(19) United States
(12) Patent Application Publication
(10) Pub. No.: US 2014/0215117 A1
(43) Pub. Date: Jul. 31, 2014

(54) ELECTRONIC DEVICE AND METHOD FOR CONTROLLING STATUS OF PCI INTERFACES

(71) Applicants: HON HAI PRECISION INDUSTRY CO., LTD., New Taipei (TW); HONG FU JIN PRECISION INDUSTRY (Shenzhen) CO., LTD., Shenzhen (CN)

(72) Inventors: MING-YI CHEN, Shenzhen (CN); HUAN DUAN, Shenzhen (CN)

(73) Assignees: HON HAI PRECISION INDUSTRY CO., LTD., New Taipei (TW); HONG FU JIN PRECISION INDUSTRY (Shenzhen) CO., LTD., Shenzhen (CN)

(21) Appl. No.: 14/159,403

(22) Filed: Jan. 20, 2014

(30) Foreign Application Priority Data
Jan. 28, 2013 (CN) 2013100308412

(51) Int. Cl. G06F 13/40

(52) U.S. Cl. CPC G06F 13/404
USPC 710/314

(57) ABSTRACT

An electronic device includes a main board. The main board includes a number of PCI interfaces, an addressing unit, a determination unit, and a control unit. The addressing unit is configured for addressing addresses of each of the PCI interfaces of the main board from an address bus of the electronic device. The determination unit is configured for determining whether any PCI interfaces are not connected to corresponding PCI devices according to a value at the addressed addresses. The control unit is configured to turn off the PCI interfaces that are not connected to corresponding PCI devices. A method for controlling status of the PCI interfaces is also provided.

### FIELD

The present disclosure relates to electronic devices, and particularly to a method for controlling a status of PCI interfaces of an electronic device.

### BACKGROUND

Peripheral component interconnect (PCI) devices, such as video cards, sound cards, or network cards, connect to a main board of a computer via PCI interfaces on the main board. However, during a startup process of the computer, PCI interfaces that are not connected to PCI devices are still turned on, which increases power consumption of the main board.

### BRIEF DESCRIPTION OF THE DRAWINGS

Many aspects of the embodiments of this disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an embodiment of an electronic device.

FIG. 2 is a flowchart of an embodiment of a method for controlling a status of PCI interfaces of the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

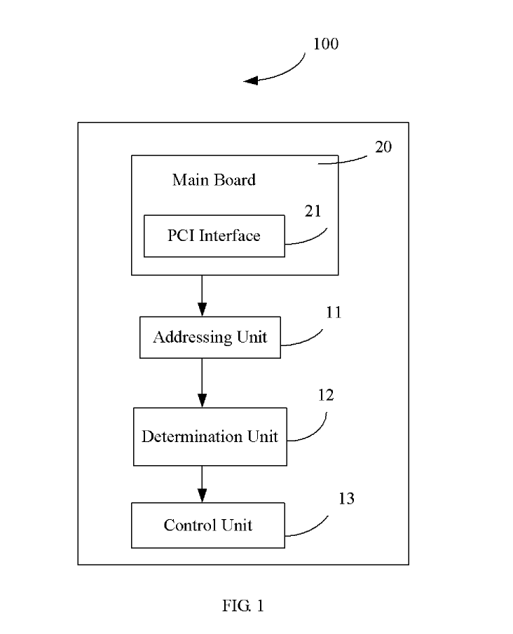

FIG. 1 shows an embodiment of an electronic device 100. The electronic device 100 includes an addressing unit 11, a determination unit 12, a control unit 13, and a main board 20. The main board 20 includes a plurality of PCI interfaces 21 (only one shown).

The addressing unit 11 is configured for addressing addresses of each of the PCI interfaces 21 of the main board 20 from an address bus (not shown) of the electronic device 100. In the embodiment, the reading unit 11 addresses the addresses of the PCI interface 21 during a startup process of the main board 20.

The determination unit 12 determines whether any of the PCI interfaces 21 are not connected to corresponding PCI devices (not shown) according to a value at the addressed addresses. In the embodiment, when the value at the addressed addresses of the PCI interfaces 21 is either a first value or a second value, the determination unit 12 determines that the PCI interfaces 21 are connected to a corresponding PCI device. For example, the first value is a hexadecimal zero, and the second value is a hexadecimal 0FF. When the value at the addressed addresses of the PCI interfaces 21 is a third value, the determination unit 12 determines that the PCI interfaces 21 are not connected to corresponding PCI devices.

When one PCI interface 21 is not connected to a corresponding PCI device, the control unit 13 turns off the PCI interface 21. In the embodiment, the control unit 13 turns off the PCI interface 21 by modifying the value at the address of the PCI interface 21. Thus, power consumption by the main board 20 is reduced.

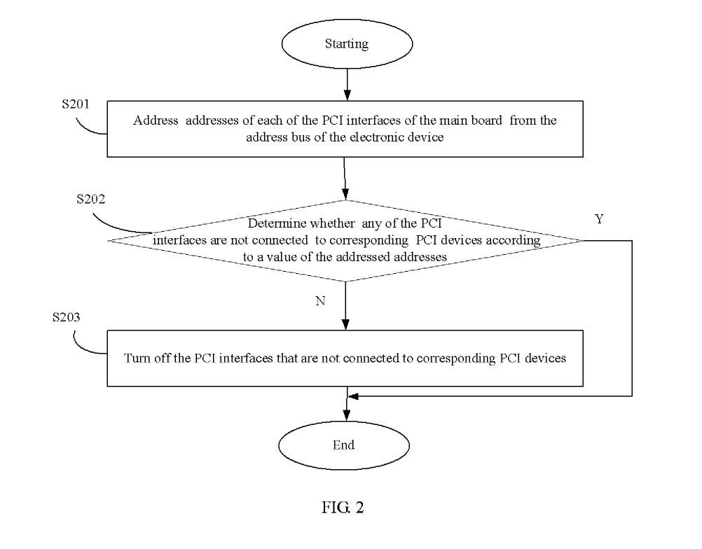

FIG. 2 shows a flowchart of a method for controlling a status of the PCI interfaces 21 of the electronic device 100.

In step S201, the addressing unit 11 addresses addresses of each of the PCI interfaces 21 of the main board 20 from an address bus of the electronic device 100 during a startup process of the main board 20.

In step S202, the determination unit 12 determines whether any of the PCI interfaces 21 are not connected to corresponding PCI devices according to a value at the addressed addresses. If no, the process goes to step S203. Otherwise, the process ends.

In the embodiment, when the value at the addressed addresses of the PCI interfaces is either a first value or a second value, the determination unit 12 determines that the PCI interfaces 21 are connected to corresponding PIC device. For example, the first value is a hexadecimal zero, and the second value is a hexadecimal 0FF. When the value at the addressed addresses of the PCI interfaces 21 is a third value, the determination unit 12 determines that the PCI interfaces 21 are not connected to corresponding PIC devices.

In step S203, the control unit 13 modifies the value at the addressed addresses of the PCI interfaces 21 that are not connected to corresponding PCI devices to turn off the PCI interfaces 21.

Although the present disclosure has been described in considerable detail with reference to certain preferred embodiments thereof, the disclosure is not for limiting the scope of the disclosure. Persons having ordinary skill in the art may make various modifications and changes without departing from the scope of the disclosure. Therefore, the scope of the appended claims should not be limited to the description of the preferred embodiments described above.

What is claimed is:

1. A method for controlling a status of Peripheral Component Interconnect (PCI) interfaces of an electronic device, the electronic device comprising a main board having at least one PCI interfaces, the method comprising:
addressing addresses of each of the at least one PCI interfaces of the main board from an address bus of the electronic device;
determining whether any of the at least one PCI interface is not connected to a PCI device according to a value at the addressed addresses of the PCI interface;
turning off the PCI interface when the PCI interface is not connected to a corresponding PCI device.

2. The method as described in claim 1, wherein addressing is executed during a startup process of the main board.

3. The method as described in claim 2, wherein the PCI interface is determined to be connected to a PCI device when the value at the addressed address is a first value.

4. The method as described in claim 3, wherein the first value is hexadecimal zero.

5. The method as described in claim 2, wherein the PCI interface is determined to be connected to a PIC device when the value at the addressed address is a second value.

6. The method as described in claim 5, wherein the second value is hexadecimal 0FF.

7. The method as described in claim 1, wherein the PCI interface is determined to be not connected to a PCI device when the value at the addressed address is a third value rather than hexadecimal zero and 0FF.

8. The method as described in claim 1, wherein turning off the PCI interface includes turning off the PCI interface by modifying the value at the address.

9. An electronic device, comprising:
a main board having at least one Peripheral Component Interconnect (PCI) interfaces;
an addressing unit, configured for addressing addresses of each of the at least one PCI interfaces of the main board from an address bus of the electronic device;
a determination unit, configured for determining whether any of the at least one PCI interfaces is not connected to a PCI device according to a value at the addressed addresses of the PCI interface;
a control unit, configured for turning off the PCI interface when the PCI interface is not connected to a corresponding PCI device.

10. The electronic device as described in claim 9, wherein the reading unit reads the addresses of each of the at least one PCI interfaces during the startup process of the main board.

11. The electronic device as described in claim 10, wherein the determination unit determines the PCI interface is connected to a PCI device when the value at the addressed address is a first value.

12. The electronic device as described in claim 11, wherein the first value is hexadecimal zero.

13. The electronic device as described in claim 10, wherein the determination unit determines the PCI interface is connected to a PCI device when the value at the addressed address is a second value.

14. The electronic device as described in claim 13, wherein the second value is hexadecimal 0FF.

15. The electronic device as described in claim 9, wherein the PCI interface is determined to be not connected to a PIC device when the value at the addressed address is a third value rather than hexadecimal zero and 0FF.

16. The electronic device as described in claim 9, wherein the control unit is configured for turning off the PCI interface by modifying the value at the address of the PCI interface when the PCI interface connects no PCI device.
